(19) United States
(12) Patent Application Publication
(10) Pub. No.: US 2025/0050681 A1
(43) Pub. Date: Feb. 13, 2025

(54) Aircraft Wheel & Bearing Protectors with Integrated Internal Protection Protrusion and Fastening Member Guide

(71) Applicants: Jose Ordonez, Valencia, CA (US); Neil Waldron, Valencia, CA (US)

(72) Inventors: Jose Ordonez, Valencia, CA (US); Neil Waldron, Valencia, CA (US)

(73) Assignee: Bill Thomas Associates, Inc, Valencia, CA (US)

(21) Appl. No.: 18/778,904

(22) Filed: Jul. 19, 2024

Related U.S. Application Data
(63) Continuation-in-part of application No. 17/740,298, filed on May 9, 2022, now Pat. No. 12,162,310.
Application No. 17/740,298 is a continuation of application No. 15/859,566, filed on Dec. 31, 2017, now Pat. No. 11,351,814.
(60) Provisional application No. 62/441,282, filed on Dec. 31, 2016.

(51) Int. Cl. B60B 7/04; B60B 7/01; B60B 7/02; B60B 7/06

(52) U.S. Cl. CPC B60B 7/04; B60B 7/01; B60B 7/06; B60B 7/02; B60B 2340/30; B60B 2900/212; B60Y 2200/51

(57) ABSTRACT

An aircraft wheel hub protector is adapted to engage an aircraft wheel including an aircraft tire on a rim. The aircraft wheel hub protector having two or more cover sections with one or more protective protrusions. The one or more protrusions retain one or more bearing races in a support section of the hub and protect an internal surface within an axle void within the hub of the rim of the aircraft wheel. The second cover section is engaged with an opposed side of the aircraft wheel from the first cover section. A coupling mechanism is provided on or engaging the at least one protective protrusion and coupling the first cover section and second cover section together, thereby securing the aircraft wheel hub protector to the aircraft wheel and retaining the at least one bearing race.

### CROSS-REFERENCE TO RELATED APPLICATIONS

This application claims the priority of U.S. provisional patent application 62/441,282, filed Dec. 31, 2016 and claims the priority of U.S. patent application Ser. No. 15/859,566, filed Dec. 31, 2017 issued as U.S. Pat. No. 11,351,814, and is a continuation-in-part of U.S. patent application Ser. No. 17/740,298 filed May 9, 2022, all of which are incorporated herein by reference.

### BACKGROUND OF THE INVENTION

### Field of the Invention

The invention relates to a device and method for providing protective protrusions in an aircraft wheel assembly protector to protect and guide a T-bar or equivalent connector to retain wheel protector elements.

### Background of the Invention

Industry leading aircraft wheel protector covers are most often designed to protect the outer surfaces of an aircraft wheel assembly from damage during transport. This includes the outer faces of the metal part of the aircraft wheel, the outward face of the bearings, the outer flanges, and in the case of wheel pallets, and the tire sidewall as well. To accomplish this, typically a protective cover is placed so as to surround the enumerated components of the wheel, the wheel rim, and the bearings. The cover is typically provided as two halves which seat inside the tire and extend outward and inward to engage the rim of the aircraft wheel assembly. The vast majority of these designs utilize what is referred to in the industry as a T-bar or its equivalent to tie both halves of the cover together and tighten it in place.

When installing the T-bar to tie or couple both halves of the cover together, it is often the case that the metal T-bar contacts the internal metal surfaces of the aircraft wheel, potentially causing nicks or scratches and most certainly transferring grease to the T-bar from the bearing surfaces. In the existing covers, the protective plastic extends about and over both the internal and external surfaces relative to the tire and rim, but there is no part of the cover that directly protects the wheel bearings and internals in situ. That is, the cover in existing designs extends over and covers the internal components from external forces and intrusions but does not in and of itself complement or directly protect these parts, even from the T-bar. Even in instances where no T-bar is used, the two halves still need to be retained and the connector elements need to be protected from dislodging or damaging bearing races and internal components while still being able to connect the protector components.

Protecting these internal components and specifically the wheel bearings is important. On some aircraft wheel assemblies, the bearings are retained with a retaining-clip. The clip is not designed for loading from stacking or impact or similar mistreatment that can be occasioned during the shipping process. Though unlikely to be fully dislodged, misalignment and damage from improper installation of the covers can occur and mishandling during shipment may also result in damage.

On a few aircraft wheel assembly models, the bearings are unretained and rely on proper installation of the wheel on the aircraft axle to keep the bearings in the proper place. For wheels with unretained bearings, it is possible for the end user installing the covers to place the T-bar through the wheel in such a way that the unretained bearing may become dislodged and fall out of the wheel assembly. This of course can lead to installation errors and dangerous conditions on the aircraft if the wheel assembly is installed without the realization that the bearing race is misaligned or missing or damaged or otherwise impaired by impact.

Thus a need exists for a wheel and bearing protector designed to protect against the encroachment of shipping and pallet packing preparations from damaging the internal components of the aircraft wheels and bearings. The needed wheel and bearing protector would provide protection to the inside of the wheel as well as the outer surfaces. To date existing aircraft wheel and bearing protectors do not provide the necessary features needed and such a device would solve a distinct problem by enhancing the protective ability of such covers.

### SUMMARY OF THE INVENTION

It is an aspect of the invention to provide internal protective protrusions in an aircraft wheel and wheel bearing cover that will both guide the installation of the T-bar for ease of installation and also protect the inner surfaces of the aircraft wheel. This feature will also prevent unretained bearings from being dislodged by inaccurate installation of the T-bar.

A further aspect of the invention is to prevent damage from misalignment of the T-bar via protrusions utilized to guide the T-bar without the possibility of it becoming engaged with the wheel bearings or race.

Still another aspect of the invention is providing a device with a built in attachment device reducing production costs and supply chain management issues. Additionally, the incorporation of the attachment device into the body of the cover renders misplacement of the attachment device impossible and therefore increases the reusability of the cover without additional costs associated with replacement for lost attachment devices.

Yet a further aspect of the invention is the prevention of damage from misalignment of the T-bar via protrusions utilized to guide the T-bar without the possibility of it becoming engaged with the wheel bearings or race.

An object of the invention is to prevent damage from ejection, misalignment, or ejection and misalignment of unretained wheel bearings via guided insertion of the T-bar via protrusions utilized to guide the T-bar without the possibility of it becoming engaged with or otherwise impinged the wheel bearings or race.

The invention includes an article of manufacture, an apparatus, a method for making the article, and a method for using the article.

The apparatus of the invention includes an apparatus with a first and second of an at least two wheel hub cover with and an at least one protrusion protecting an internal hub and/or journaled bearings and a coupling arrangement for coupling the first and second wheel of the at least two cover portions with the protrusion engaged with the internal hub and/or journaled bearings.

The apparatus of the invention further includes an aircraft wheel hub protector adapted to engage an aircraft wheel, including an aircraft tire on a rim, with the aircraft wheel hub protector. A first cover section of an at least two cover sections is provided. A protective protrusion and coupling mechanism guide extending from the first cover section of an at least one cover section and passing through a bearing race and internal surface within a hub of the rim of the aircraft wheel in such a fashion as to provide a void within the protective protrusion. A second cover section of an at least two cover section is provided and engaged with an opposed side of the aircraft wheel from the first cover section of an at least two cover sections. A coupling mechanism is also provided, with the coupling mechanism passing through the void in the protective protrusion and thereby passing through the aircraft wheel and rim without having access to the bearing race and internal surface within the hub of the rim of the aircraft wheel and coupling the first cover section of an at least two cover sections to the second of an at least two cover sections and securing the aircraft wheel hub protector to the aircraft wheel.

The apparatus of the invention includes an aircraft wheel hub cover configured to be removably affixed on an aircraft wheel, the aircraft wheel having a rim and a hub with an axle void passing through the hub within the rim, including an at least two wheel hub cover portions with a first wheel hub cover portion of the at least two wheel hub cover portions on a first side of said wheel and a second wheel hub cover portion of the at least two wheel hub cover portions on an opposed side of the wheel relative to the first. An integral protection protrusion portion extends from each of the at least two wheel hub cover portions, with the integral protection protrusion on the first of the at least two wheel hub cover portions engaging a support portion of the hub that extends radially inward from the rim in the radially middle portion of the rim with an at least one bearing race groove thereon on the at least one side of said wheel and penetrating and extending past the support section and into the axle void from the first side. An at least one bearing race seated in the bearing race groove in the support portion, wherein the protection protrusions engage one another on at least a portion of each of the respective integral protection protrusions such that the integral protection protrusions releasably couple the first wheel hub cover portion to the opposed second wheel hub cover portion and thereby retain the at least one bearing race in the support portion and protect the interior surface of the axle void.

The aircraft wheel hub can additionally include an opposed side support portion of the hub that extends radially inward from the opposed side of the rim on the opposed side of the wheel in the radially middle portion of the opposed side of the rim with an at least one opposed side bearing race groove thereon. The protective protrusion can extend from the second of the at least two wheel cover portions engaging said opposed support portion of the hub. The aircraft wheel hub cover can further include an at least one opposed side bearing race seated in an at least one opposed bearing race groove in the opposed support portion.

The protective protrusion extending from the second of the at least two wheel cover portions when engaged with the protective protrusion can extend from the first of the at least two wheel cover portions retains the at least one opposed side bearing race in said at least one opposed bearing race groove. The protective protrusion extending from the first and second of the at least two wheel cover portions can form and can be releasably coupled by at least one of an at least one paired thread/thread receiving portions, a set of pressure release components, and a slip fit coupling with a push-press release component, thereby affixing the aircraft wheel hub cover to the aircraft wheel.

The protective protrusion extending from the first of the at least two wheel cover portions can have a threaded portion thereon. The protective protrusion extending from the second of the at least two wheel cover portions has a thread receiving portion thereon and wherein said protective portions are screwed together by engaging the respective threaded and thread receiving portions to removable affix the wheel hub cover portion.

The protective protrusion extending from the first of the at least two wheel cover portions can have a thread portion thereon and said protrusion from said first of the at least two cover portions can extend fully through the axle void to mate with the second of the at least two cover portions which can have as a threaded receiving portion as the second protective protrusion within the second of the at least two cover portions, where said protective portions can be screwed together by engaging the respective threaded and thread receiving portions to removably affix the wheel hub cover to the aircraft wheel.

The apparatus of the invention also includes an aircraft wheel hub cover configured to be removably affixed on an aircraft wheel having a rim and a hub with a support portion of the hub that extends radially inward from the rim in the radially middle portion of the rim with an at least one bearing race groove thereon, an at least one bearing race located in an at least one bearing race groove, and an axle void passing through the hub on the rim, including at least two wheel hub cover portions, a first wheel hub cover portion of the at least two wheel hub cover portions on a first side of said wheel, a second wheel hub cover portion of the at least two wheel hub cover portions on an opposed side of the wheel relative to the first. With an at least one integral protection protrusion portion extending from said first wheel hub cover portion of the at least two wheel hub cover portions, with the at least one integral protection protrusion engaging said support portion of the hub with said at least one bearing race groove thereon on at least one side of said wheel and penetrating and extending into the axle void from the first side to the second side of said wheel. Where the at least one integral protection protrusion extending from the first of the least two wheel hub cover portions retains said at least one bearing race in the at least one bearing race groove and engages the second cover portion of the at least two cover portions such that the at least one integral protection protrusion releasably couples the first wheel hub cover portion to the opposed second wheel hub cover portion and thereby releasably affixes the wheel cover to the aircraft wheel.

The wheel hub cover further including an opposed side support portion of the hub that extends radially inward from the opposed side of the rim on the opposed side of the wheel in the radially middle portion of the opposed side of the rim with an at least one opposed side bearing race groove thereon and wherein the at least one protective protrusion further comprises a second protective protrusion of the at least one protrusion extending from the second of the at least two wheel cover portions and engaging said opposed support portion of the hub.

The aircraft wheel hub can further include an at least one opposed side bearing race seated in an at least one opposed bearing race groove in the opposed support portion. The protective protrusion extending from the first of the at least two wheel cover portions has a threaded portion thereon. The protective protrusion can extend from the second of the at least two wheel cover portions can have a thread receiving portion thereon and wherein said protective portions are screwed together by engaging the respective threaded and thread receiving portions to removable affix the wheel hub cover portion. The second protective protrusion of the at least one protective protrusion can be engaged with the first protective protrusion of the at least two protective protrusions such that the threaded portion and the thread receiving portions are turned to engage one another and the at least two wheel cover portions retains the at least one opposed side bearing race in said at least one opposed bearing race groove.

The at least one protective protrusion extending from the first of the at least two wheel cover portions can be releasably coupled by at least one of an at least threaded portion, a set of pressure release components, a slip fit coupling with a push-press release component, thereby releasably affixing the aircraft wheel hub cover to the aircraft wheel. The at least one protective protrusion extending from the first of the at least two wheel cover portions can be provided with a thread portion thereon and extends fully through the axle void to mate with an at least one thread receiving portion within the second of the at least two cover portions, wherein said protective portions can be screwed together by engaging the respective threaded and thread receiving portions to removably affix the wheel hub cover to the aircraft wheel.

The method of the invention includes a method of using an aircraft wheel cover with protective protrusions on an aircraft wheel, comprising the steps of aligning a first of an at least two wheel cover portions, the first wheel cover portion having an at least one protrusion thereon; aligning a second of an at least two wheel cover portions, passing the at least one protrusion through the aircraft wheel, the aircraft wheel having a rim and a hub with an at least one bearing race therein, the at least one protrusion thereon being thereby engaged with the aircraft wheel such that the protrusion extends to and engages the second wheel cover through the hub; passing an at least one securement device through the at least one protrusion and inserting said securement device into the at least one protrusion such that the at least one protrusion guides the at least one securement device through the hub while protecting the at least one bearing race and an at least one internal surface; and securing the first of the at least two wheel cover portions to the second of the at least two wheel cover portions with the at least one securement device, wherein the first portion of the at least two wheel cover is coupled to the second of the at least two wheel cover portions.

The method of the invention includes a method of using an aircraft wheel cover such that an at least one protective protrusion is engaged and retains an at least one bearing race in a support portion of the wheel on an aircraft wheel, including aligning a first of an at least two wheel cover portions, the first wheel cover portion having an at least one protrusion thereon, the at least one protrusion being aligned with an axle void; passing the at least one protective protrusion into the axle void in the aircraft wheel, the aircraft wheel having aircraft wheel having a rim and a hub with the support portion of the hub that extends radially inward from the rim in the radially middle portion of the rim with an at least one bearing race groove thereon, the at least one protrusion thereon being thereby engaged with the aircraft wheel such that the protrusion extends to and engages a second wheel cover portion of the at least two cover portions through the axle void in the hub; engaging an at least one coupling portion of the at least one protrusion to releasably affix the first cover portion of the at least two cover portions to the second cover portion of the at least two cover portions; and securing and retaining the at least one bearing race in the support portion of the wheel while the aircraft wheel cover is releasably affixed.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

FIG. 1A shows a cross section of a prior art aircraft wheel cover with a misaligned T-bar.

FIG. 1B shows a close up of the aircraft wheel cover of FIG. 1A showing the misalignment of the T-bar in the hub of the wheel impacting the bearing race and internal surfaces.

FIG. 2 shows an exploded view of an exemplary embodiment of the instant invention an aircraft wheel and bearing protector assembly.

FIG. 3 shows a cross section of an assembled upper and lower protective cover members of the exemplary embodiment of FIG. 2.

FIGS. 4A-C show the steps of an exemplary method for installing the exemplary embodiment of FIG. 2 on an aircraft wheel.

FIG. 5 shows a isometric exploded view of a further exemplary embodiment of the instant invention.

FIGS. 6A and 6B show a further assembly side view and cross sectional view along line A-A respectively of the exemplary embodiment of FIG. 5.

FIGS. 7A-7C show a process of engaging the cover portions with one another and installing the exemplary embodiment of FIG. 5.

FIG. 8A-8B show a further embodiment of the instant invention having a smaller threaded receiving section and an extended mating threaded section.

FIG. 9A-9B shows the cross section of the further embodiment of FIG. 8A-8B of the invention on a wheel having two bearing races and an opposed support section on an opposed side of the wheel engaging the second race.

### DETAILED DESCRIPTION OF THE INVENTION

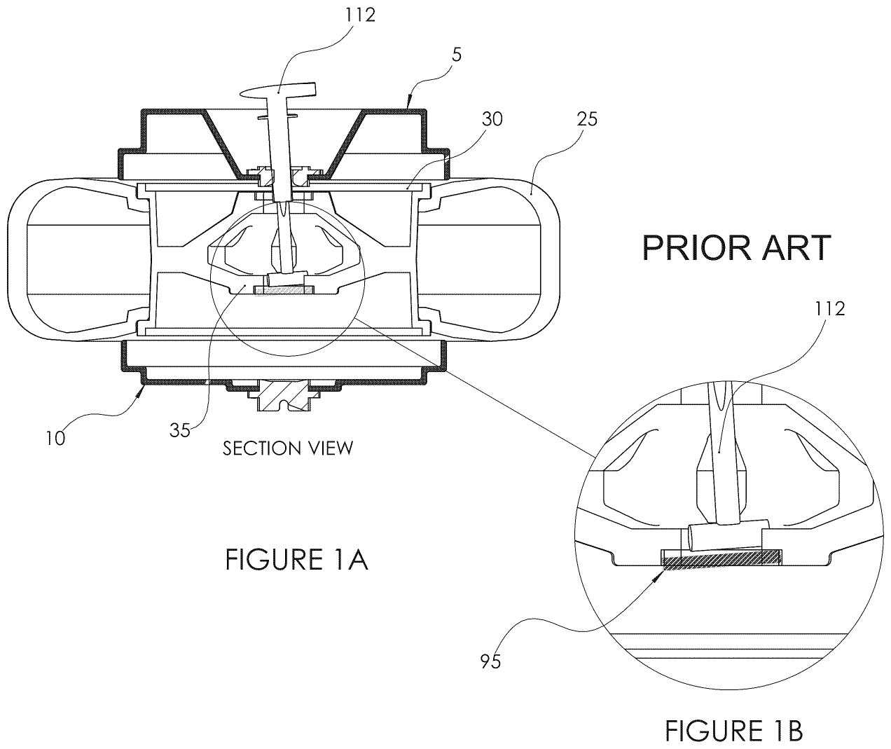

FIG. 1A shows a cross section of a prior art aircraft wheel cover with a misaligned T-bar. An aircraft wheel cover 1 is shown with a protective cover 5, 10 coupled together by a securing device, here a metal T-bar 112. As seen in the figure the protective cover provides protection against exterior forces and impacts to areas within the tire, rim and wheel hub. However, the surfaces inside the hub of the wheel remain exposed to the T-bar 112 during the insertion of the T-bar 112 into the device.

As noted and shown in FIG. 1A, in the prior art when installing the T-bar 112 to tie both halves of the prior art cover together the metal T-bar 112 can come in contact with the internal metal surfaces of the aircraft wheel if not installed properly. The improper installation can cause nicks or scratches and transfers grease to the T-bar from the internal surfaces 96 and bearing races 95, depriving them of the needed protection of the grease. In the prior art covers, the protective plastic cover extends about and over the tire and rim. But there is no part of the cover 5,10 that protrudes into the area of axle mounting point and directly protects the wheel bearing races 95 and internal surfaces 96 in situ from the T-bar 112. That is, the cover 5,10 extends over and covers the internal components from external forces and intrusions but does not in and of itself complement or directly protect these parts from the T-bar or similar objects inserted or thrust within it that impacts the internal components in any fashion.

Protecting these internal components and specifically the wheel bearings is important in the proper operation of the wheel on the aircraft. On some aircraft wheel assemblies, the bearings are retained with a retaining-clip. The clip is not designed for loading from stacking or impact or similar mistreatment that can be occasioned during the shipping process. Though unlikely to be fully dislodged, misalignment and damage from improper installation of the prior art cover and its T-bar can occur and mishandling during shipment may also result in damage.

In addition a few aircraft wheel assembly models, the bearings are not retained or unretained and rely on proper installation of the wheel on the aircraft axle to keep the bearings in the proper place. For wheels with unretained bearings, it is possible for the end user installing the prior art covers depicted to place the T-bar through the wheel in such a way that the unretained bearing may become dislodged and fall out of the wheel assembly. This of course can lead to installation errors and dangerous conditions on the aircraft if the wheel assembly is installed without the realization that the bearing race is misaligned or missing or damaged.

FIG. 1B shows a close up of the aircraft wheel cover of FIG. 1A showing the misalignment of the T-bar 112 in the internal surfaces 96 and wheel race bearing 95 of the aircraft wheel assembly 25. The misalignment of the coupling device, using the example of a T-bar 112 as shown, as an example of the type of error that can occur and cause the damage to the internal components of the wheel hub due to the prior art design. Misalignment and damage from improper installation of the covers and the fastening device, here T-bar 112, can occur when the exposed bearing surfaces 96 and bearing races 95 inside the hub 35 are impacted by the T-bar 112. This damage can also occur from mishandling during shipment impacting the T-bar 112. And on some aircraft wheel assembly models, as previously noted, the bearings races 95 and internal surfaces 96 are not retained and rely on proper installation of the aircraft wheel 25 on the aircraft axle to keep the bearing race(s) 95 in the proper place. For such installations with unretained bearings, it is very possible for the end user installing the covers to place the T-bar through the wheel in such a way that the unretained bearing races 95 may becomes dislodged and falls out of the aircraft wheel hub 35 and get lost in transit or during packing.

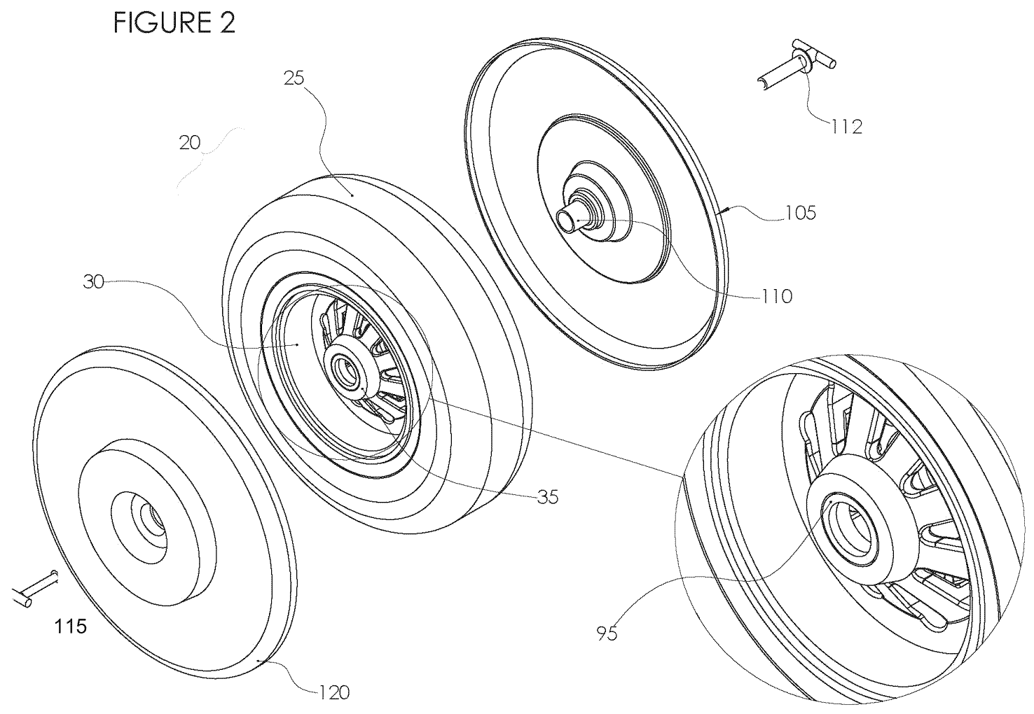

FIG. 2 shows an exploded view of an exemplary embodiment of the instant invention an aircraft wheel and bearing protector assembly. The exemplary embodiment shown provides an aircraft wheel and bearing protector with integrated internal protection protrusion and T-bar fastening guide. An aircraft wheel 20 is shown comprising a tire 25 on a rim 30, having a hub 35, and a bearing race 95 and internal surfaces 96. An exemplary embodiment of an aircraft wheel cover is shown in a disassembled state. A first cover section 105 is attached to one side of the aircraft wheel 20. A protective protrusion and guide 110 is provided such that it extends through the hub 35 and protects the bearing race 95 and internal surface 96. Although two cover sections 105, 120 are provided in the exemplary embodiment, nothing prohibits further protective elements or fewer protective members being included in further exemplary embodiments of the invention. However at least two protective elements are provided to cover each side of the wheel 20 in this embodiment.

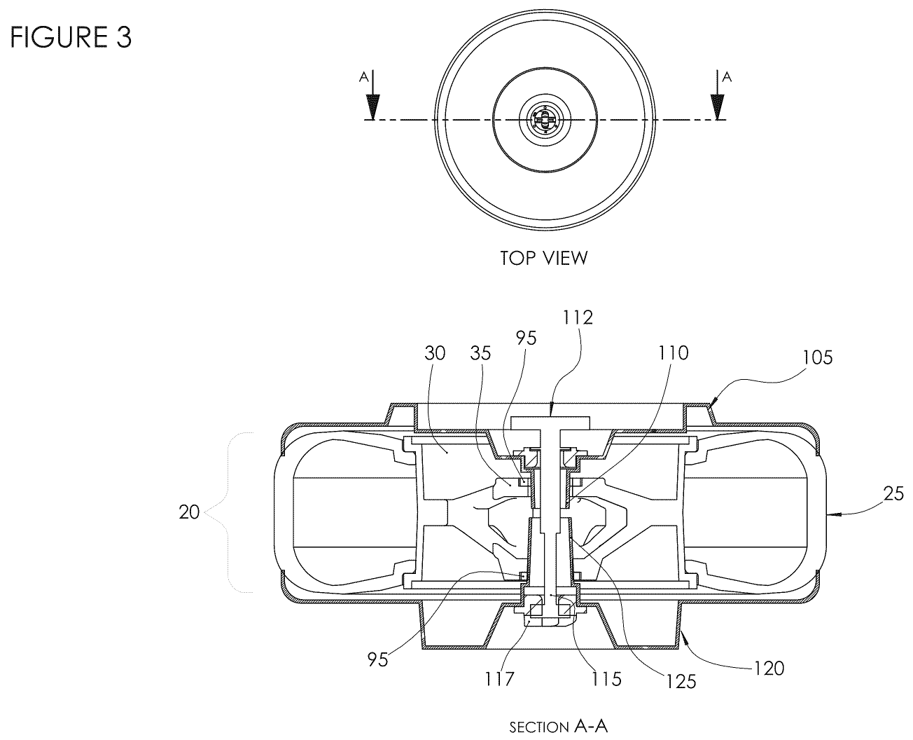

A second cover section 120 is provided and aligned with an opposed side of the aircraft wheel 20 from the first cover section 105. A protective protrusion and guide 125 is provided on the second cover section, as better seen in FIG. 3. Although the exemplary embodiment utilizes two such protrusions, further exemplary embodiments are contemplated whereby a single protrusion is provided and still further embodiments utilizing several protrusions are contemplated. The importance of the protrusion element or elements being evident in that they provide protection for the components that are internal to the hub 35 of the aircraft wheel 20 and the bearing races 95 and internal surfaces 96 therein.

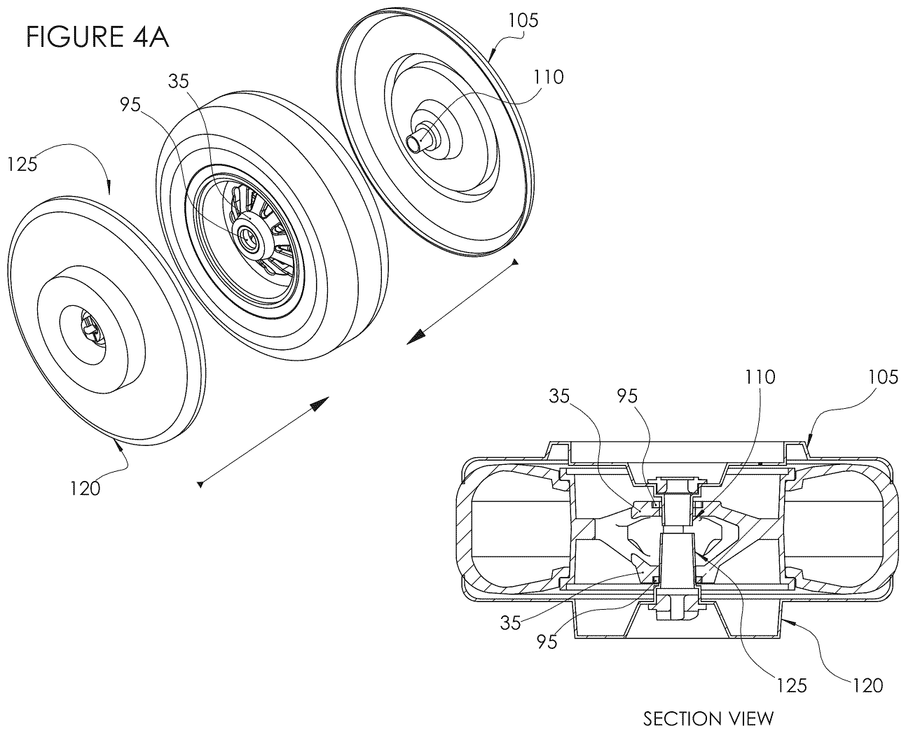

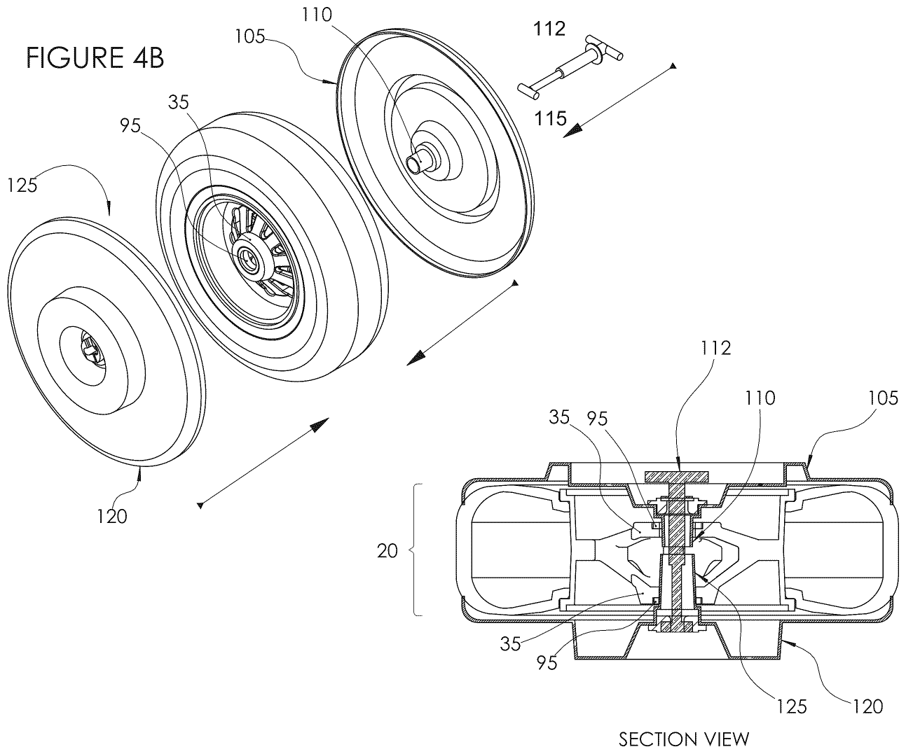

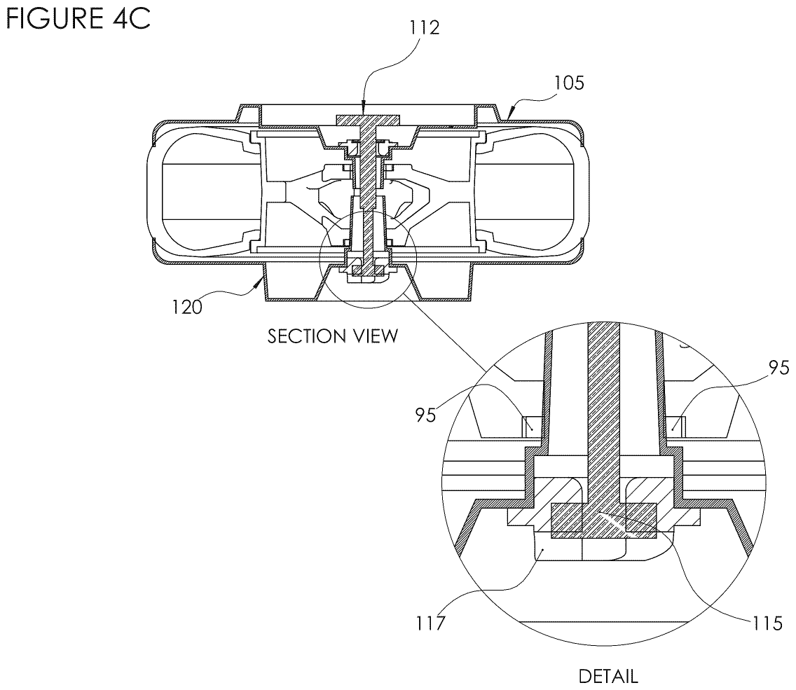

The first and second cover sections 105, 120 are arranged during installation in a manner in which the exterior of the wheel 20 to the rim 30 as shown to protect the rim 30 and the hub 35 and the internal surfaces 96 and bearing race 95 of the hub 35 from damage. This is further shown and discussed in relation to FIGS. 4A-C below showing the installation process.

FIG. 3 shows an assembled view of the upper and lower protective cover members of the exemplary embodiment of FIG. 2 without the aircraft tire. This view more clearly shows the assembly of the exemplary embodiment of FIG. 2 as installed. As more clearly seen in this figure, the protrusions 110, 125 extend from the first cover portion 105 and second portion 120 of an at least two cover portions respectively and penetrate through the hub 35 of the rim 30 and simultaneously through the bearing race 95 and internal surfaces 96 to protect same. The extended securing member, in this instance T-bar 112, passes through the first cover portion 105 of the wheel cover 100 and along the protrusions 110, 125, protecting the bearing race/internal surfaces 95, and through to the second cover portion 120 of the wheel cover 100 where the T-bar 112 has a threaded end 115 which extends out and is engaged and secured by a securing member 117, here shown as a nut attached to a threaded end.

FIGS. 4A-C show the steps of the method for installing the exemplary embodiment of FIG. 2 on an aircraft wheel. In a first step, shown in FIG. 4A. In an exemplary method of installation, in a first step the first cover section 105 is located above the aircraft wheel 20 with the protrusion and guide 110 aligned with the hub 35 and bearing race 95 and internal surfaces 96. A second cover portion 120 is aligned on the side opposite the first cover section 105, the protrusion and guide 125, extending from the second cover portion 120 and also being aligned with the hub 35 and bearing race 95 and internal surface(s) 96. The first and second portion of an at least two cover portions 105, 120 being moved into communication with one another such that the protrusion and guides 110, 125 passes through the hub 35 and bearing race and internal surface 95 of the aircraft wheel assembly 20.

FIG. 4B shows a further step in the installation of the exemplary embodiment of the invention shown in FIG. 2. In a second step, as shown in FIG. 4B, an extended securing member, here shown as a T-bar 112, is separated from its end 115 and then aligned with the protrusion and guides 110, 125 and inserted into the protrusion and guide 110, 125 such that the extended securing member 112 passes through both the first and second portions of the instant invention. As noted above, the protrusion and guide 110, 125 prevent the extended securing member 112 from contacting the bearing race or internal surfaces, protecting the aircraft wheel assembly 20 from improper installation of the securing member 112, dislodgement of or impact with the internal surfaces and the bearing race 95 of the wheel assembly 20, and other issues involving the alignment of the instant invention or the securing member 112.

FIG. 4C shows a further step in the installation of the exemplary embodiment of the invention shown in FIG. 2. In a third step shown in FIG. 4C, the extending securing member 112 has its end 115 that is engaged with a securing member 117 for example but certainly not limited to a nut, and the instant invention secured to the aircraft wheel 20 without impacting the bearing race or its internal components 95 while positively and properly aligning the extended securing member 112 to affix the aircraft wheel cover 100 to the aircraft wheel assembly 20.

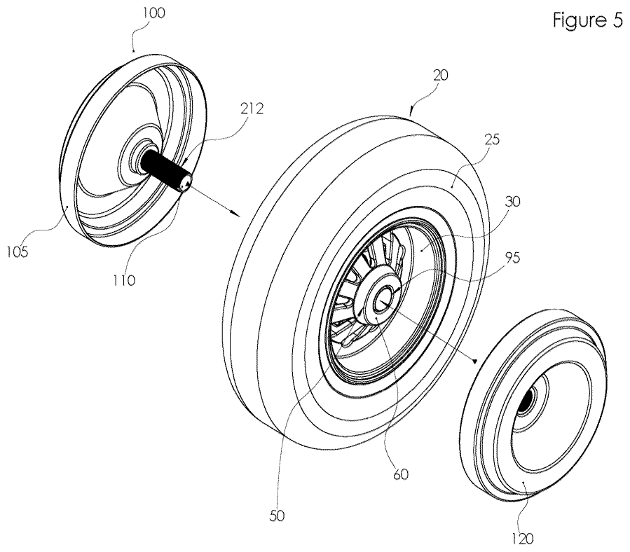

FIG. 5 shows an isometric view of a further exemplary embodiment of the instant invention. The further exemplary embodiment of FIGS. 5-7C eliminates the separate attachment member, shown in the exemplary embodiment of FIGS. 1-4C as T-Bar 112, thus improving cost efficiency and convenience for the end user.

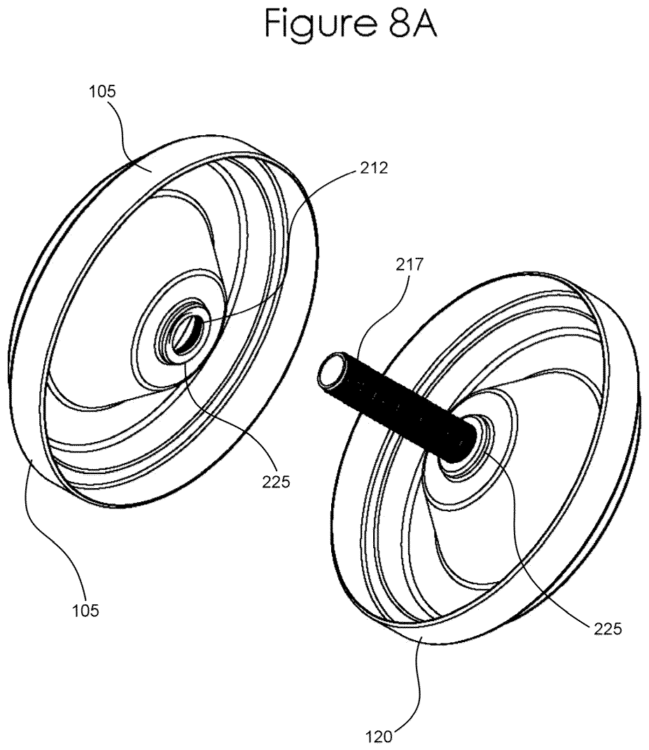

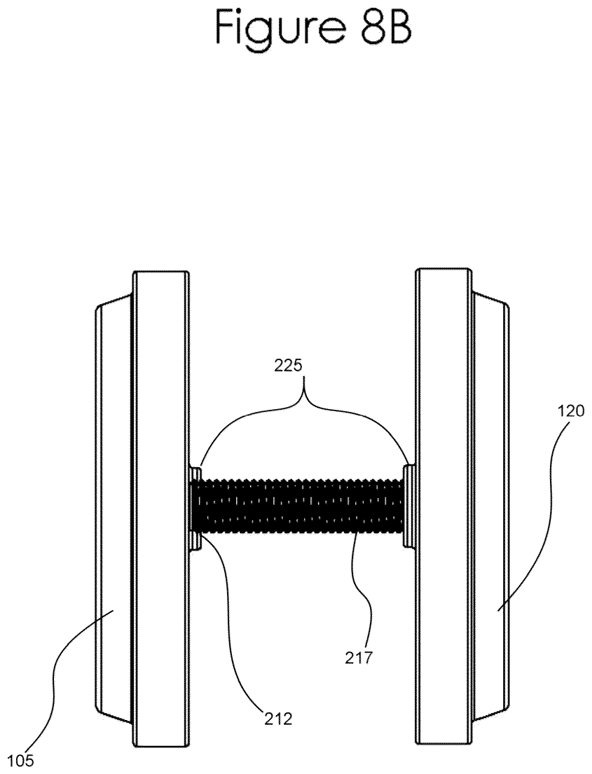

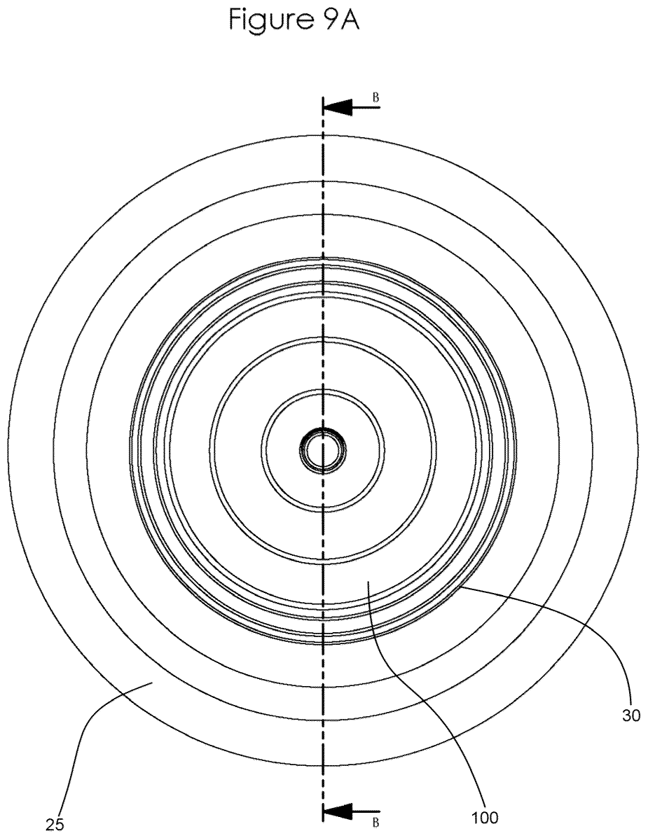

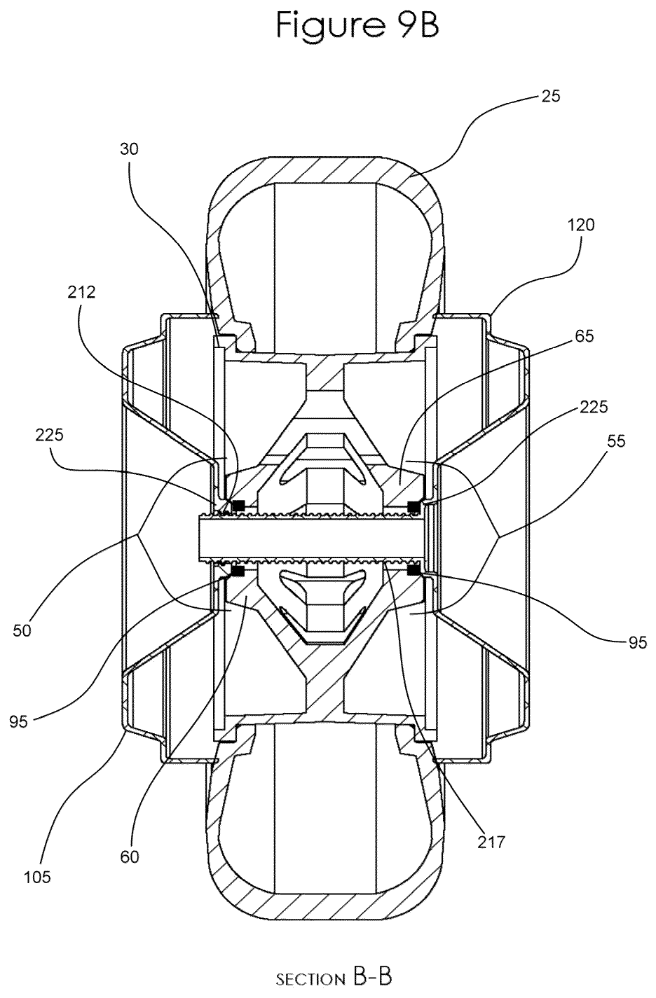

Again, an aircraft wheel 20 is provided, having a rim 30 with a hub or hub portion 35 and a tire 20. The hub or hub portion 35 has a support portion 60 that extends radially inward from the rim 30 into the radially middle portion 50 of the rim 30 with one or more bearing race(s) 95 in a bearing race seat. An opposed or second support portion 65 can be disposed on an opposite side of the rim 30 in the opposite radially middle portion 55 of the opposite side of the hub or hub portion 35, as better shown in the embodiment of FIG. 8-9. A void 70 passes through the hub or hub portion 35 on the rim 30 permitting an axle (not shown) to pass through or into the rim 30 and hub or hub portion 35 while engaging the bearing race(s) 95 when mounted on an aircraft (not shown).

A wheel cover 100 is provided having one or more portions or members 105, 120 that cover the aircraft wheel rim 30 and the hub portion(s) 35. The hub cover portions or members 105, 120 retain the one or more bearing race(s) 95 in the rim 30 during transport in this embodiment and provide protection for the void 70, the internal surfaces of the void 96, and preventing dislodgment of the one or more bearing races 95 during transport. The exemplary embodiment of FIG. 5 employs an extended molded plastic protrusion 210, 217 on each hub cover portion(s) or member(s) 105, 120. The protrusions can be solid or hollow, but provide extension into the hub with the threaded coupling portions and past the support section to couple or connect and thereby retain the bearing race(s) during transport.

The plastic protrusions 210, 217 extending from the cover portions or members 105,120, which although shown as two portions can be one or more cover portions, provide a threaded portion 212 on protrusion 210 extending from the first or inner cover portion or member 105, and a molded plastic threaded receiver portion 220 on protrusion 217 extending from a second a second or outer portion or member 120. The respective threaded portion 212 and thread receiving portions 220 are designed to interfit and screw together, thus joining the two wheel cover portions or members 105, 120 and passing the protrusions 210, 217 through the entirety of the axle, protecting its internal surfaces, as well as retraining the bearing race(s) 95 when the wheel cover 100 is engaged and the threaded portion and thread receiving portions 212, 220 are tightened together.

As in previously disclosed exemplary embodiments, a need was identified to protect the inner bearing race and inner metal portion of aircraft wheels. The exemplary embodiment of FIG. 5 enhances that protection as well as simplifies the number of components needed to achieve the desired protections and ensures that the components for proper installation are available with the cover. It also extends protection of the hub and axle portions as the plastic members extend through the hub. And importantly, the elimination of the T-Bar attaching device removes associated cost and lead time with production. Thus the exemplary embodiment of FIG. 5 reduces overall cost and reduces supply chain issues as the entire wheel cover can be single sourced and manufactured via plastic molding giving the ability to produce a more useful product, due to the integral nature of the coupling elements, more cost-effectively, and in a more timely manner.

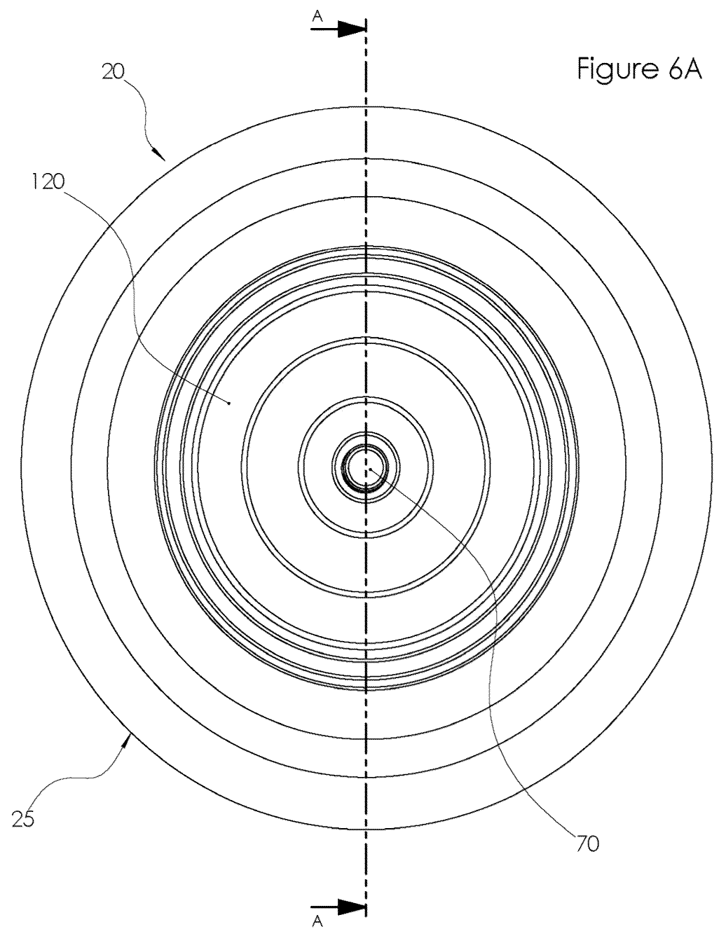

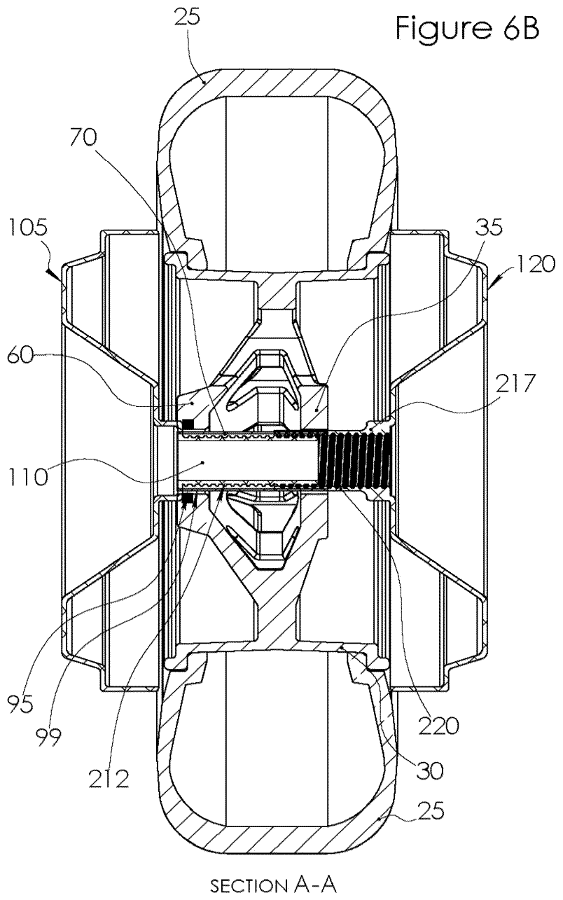

FIGS. 6A and 6B show a further assembly side view and cross sectional view along line A-A respectively of the exemplary embodiment of FIG. 5. As seen in FIGS. 6A and 6B, an aircraft wheel 20 is provided, having a rim 30 with a hub or hub portion 35 and a tire 20. The hub or hub portion 35 has a support portion 60 that extends radially inward from the rim 30 into the radially middle portion 50 of the rim 30 with one or more bearing race(s) 95 in a bearing race seat. The wheel cover 100 couples to and retains the bearing race 95 in the support portion 60 with an at least one protrusion 210, 217, as described above. The cross section view of FIG. 6B more clearly shows the protective protrusions 210, 217 extending through and meeting to engage one another through the void 70 with threaded section 212 and thread receiving section 220 screwed together so as to retain the cover portions or members 105, 120 of the wheel hub cover 100 to one another.

In this embodiment the cover portions or members are releasably coupled by the threaded and thread receiving portions 210, 217 shown, however, it would be apparent to one of ordinary skill in the art that other integral elements could be used to engage the protrusion. Some non-limiting examples include slip fitting sections with pressure release components, push-press tabs with respective receiving elements, and the like. Additionally, aircraft wheels can typically include one or more bearing races and in this instance, as can be seen in this cross section, this embodiment engages a single bearing race on the aircraft wheel. FIG. 8 below shows a version having a similar opposed side with similar support section and an additional bearing race and though two bearing races are shown in FIG. 8, multiple bearing races per side, though atypical for current aircraft, are contemplated in further embodiments of the instant invention.

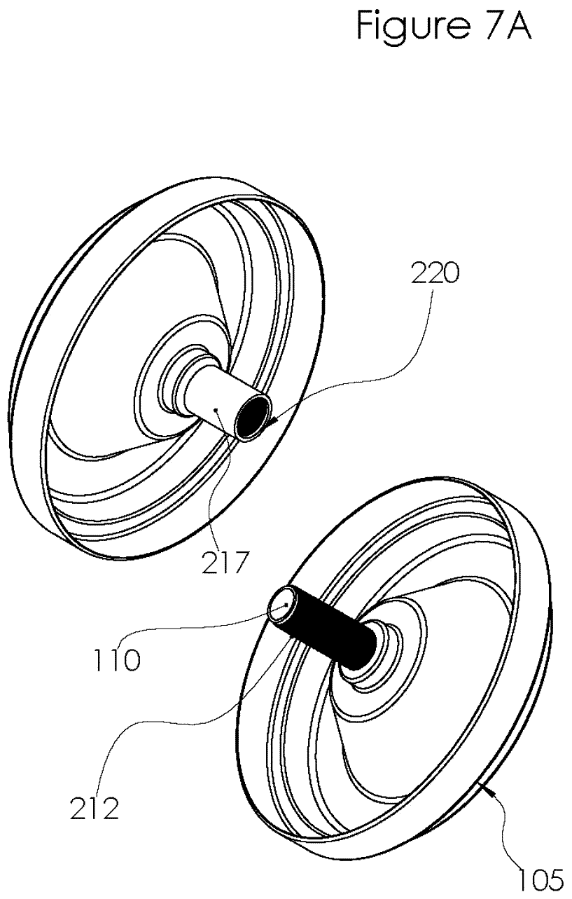

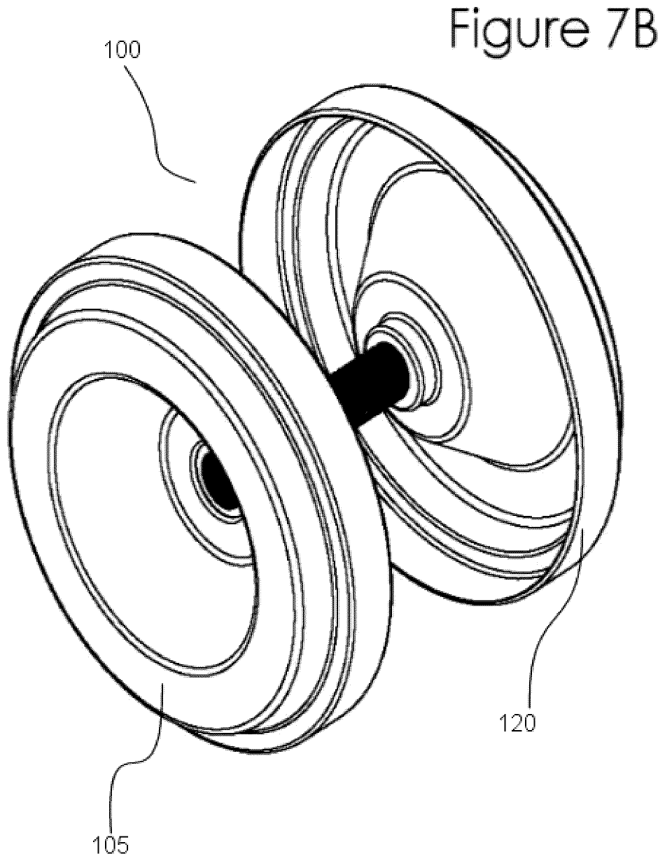

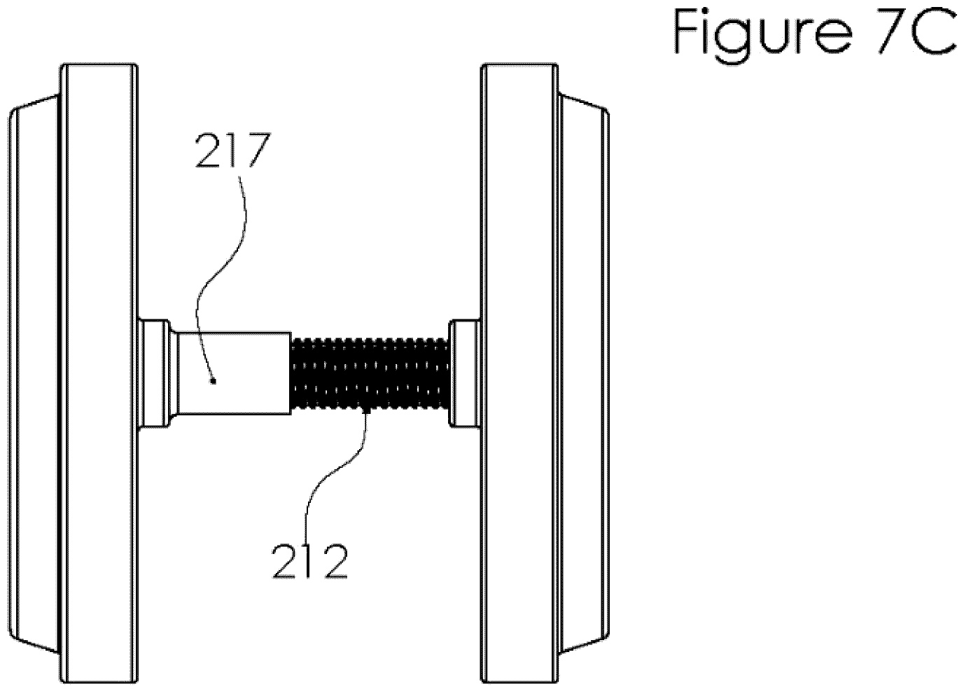

FIGS. 7A-7C show a process of engaging and installing the exemplary embodiment of FIG. 5. The protrusions 210, 217 are more clearly shown, each respectively having the threaded portion 212 and the thread receiving portion 220, with the threads more clearly shown in FIG. 7A. The threaded portion 212 is clearly shown inserted and screwed into the thread receiving portion 220 in FIGS. 7B isometric and 7C side views. As seen in FIG. 6B, when inserted and coupled as shown the protrusion is designed to pass through the void 70 for the axle and simultaneously secure the bearing race 95 in the hub portion 35.

The incorporation of the retaining member as an integral component of the wheel cover further ensures that the wheel hub cover can always be installed and retained properly as installation would be completed by simply rotating either or both halves in opposite directions whilst engaging the threaded portions. Improvements in the method of manufacture allow for the threaded receiving portion and threaded protrusion portion to be molded seamlessly with the respective bodies of the wheel protector and achieve desired strength and protective qualities. The integral connection formed by the respective protrusions obviates the need for the t-bar shown in other exemplary embodiments. The single process used to form the protrusions minimizing the impact of supply chain issues and reducing costs to produce the resulting wheel cover. Finally, as the integral coupling elements are integral to the cover members or sections, it is not possible to lose or misplace the coupling element. This is an added efficiency for using the exemplary embodiments of FIGS. 5-8.

FIGS. 8A and 8B show an exploded view and assembled view respectively show a further embodiment of the instant invention having a smaller threaded receiving section and an extended mating threaded section. As with prior embodiments, a wheel cover 100 is provided having one or more portions or members 105, 120 that cover the aircraft wheel rim 30 and the hub portion(s) 35. The hub cover portions or members 105, 120 retain the one or more bearing race(s) 95 in the rim 30 on both sides in this embodiment during transport and provide protection for the void, the internal surfaces of the void, and prevent dislodgment of the one or more bearing races 95 during transport.

The exemplary embodiment of FIG. 8A-8B employs an extended molded plastic protrusion 217, with a shorter threaded receiving portion 212 on each of the respective hub cover portion(s) or member(s) 105, 120. In this instance, the shorter threaded receiving portion 212 extends again past the bearing race 95 and into the axle void but is shorter or nearly flush with the back of the respective hub cover portion 120 as shown. Both portions 212, 217 are situated with a raised portion 225 which penetrates into the void section and assures the races 95 are held in place. The extended plastic protrusion 217 in this instance passes through the entire axle void 70 to mate with the threaded receiving portion 211, as best see in FIGS. 8B and 9A-B. The protrusion can again be solid or hollow, but provide extension into the hub and past the support section to mate with the hub cover portions 105,120 coupling the cover 100 to the wheel 20 and thereby retaining the bearing races 95 during transport. Again, aircraft wheels can typically include one or more bearing races and in this instance, as can be seen in this cross section of 9B, this embodiment engages two bearing races on the aircraft wheel. Versions having multiple bearing races per side, though atypical for current aircraft, are contemplated in further embodiments of the instant invention.

FIG. 9A-9B shows the cross section of the further embodiment of FIG. 8A-8B of the invention on a wheel having two bearing races and an opposed support section on an opposed side of the wheel engaging the second race. Again, an aircraft wheel 20 is provided, having a rim 30 with a hub or hub portion 35 and a tire 20. The hub or hub portion 35 has a support portion 60 that extends radially inward from the rim 30 into the radially middle portion 50 of the rim 30 with one or more bearing race(s) 95 in a bearing race seat on a first or principle side of the wheel 20. A second or opposed support portion 65 is shown disposed on an opposite side of the rim 30 with one or more bearing race(s) 95 in a bearing race seat or groove in the opposite radially middle portion 55 of the opposite side of the hub or hub portion 35. The void 70 passes through the hub or hub portion 35 on the rim 30 permitting an axle (not shown) to pass through or into the rim 30 and hub or hub portion 35 while engaging the bearing race(s) 95 when mounted on an aircraft (not shown).

Again, a wheel cover 100 is provided having one or more portions or members 105, 120 that cover the aircraft wheel rim 30 and the hub portion(s) 35. The hub cover portions or members 105, 120 retain the one or more bearing race(s) 95 in the rim 30 on both sides in this embodiment during transport and provide protection for the axle void, the internal surfaces of the axle void, and prevent dislodgment of the one or more bearing races 95 during transport. The exemplary embodiment of FIG. 8 also employs the extended molded plastic protrusion 217 with the threaded receiving portion 212 on each of the respective hub cover portion(s) or member(s) 105, 120. Again, aircraft wheels can typically include one or more bearing races and in this instance, as can be seen in this cross section, this embodiment engages two bearing races on the aircraft wheel as shown. The coupling of the hub cover portions 105, 120 engage the respective middle portions of each wheel with the respective extension portions of the hub cover which, when joined, retain the two bearing races 95 in this wheel in place during transport as shown.

The embodiments and examples discussed herein are non-limiting examples. The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. An aircraft wheel hub cover configured to be removably affixed on an aircraft wheel, the aircraft wheel having a rim and a hub with an axle void passing through the hub within the rim, comprising:
an at least two wheel hub cover portions;
a first wheel hub cover portion of the at least two wheel hub cover portions on a first side of said wheel;
a second wheel hub cover portion of the at least two wheel hub cover portions on an opposed side of the wheel relative to the first;
an integral protection protrusion portion extending from each of the at least two wheel hub cover portions, with the integral protection protrusion on the first of the at least two wheel hub cover portions engaging a support portion of the hub that extends radially inward from the rim in the radially middle portion of the rim with an at least one bearing race groove thereon on the at least one side of said wheel and penetrating and extending past the support section and into the axle void from the first side; and
an at least one bearing race seated in the bearing race groove in the support portion, wherein the protection protrusions engage one another on at least a portion of each of the respective integral protection protrusions such that the integral protection protrusions releasably couple the first wheel hub cover portion to the opposed second wheel hub cover portion and thereby retain the at least one bearing race in the support portion and protect the interior surface of the axle void.

2. The aircraft wheel hub cover of claim 1, further comprising an opposed side support portion of the hub that extends radially inward from the opposed side of the rim on the opposed side of the wheel in the radially middle portion of the opposed side of the rim with an at least one opposed side bearing race groove thereon.

3. The aircraft wheel hub cover of claim 2, wherein the protective protrusion extending from the second of the at least two wheel cover portions engaging said opposed support portion of the hub.

4. The aircraft wheel hub cover of claim 3, further comprising an at least one opposed side bearing race seated in an at least one opposed bearing race groove in the opposed support portion.

5. The aircraft wheel hub cover of claim 4, wherein the protective protrusion extending from the second of the at least two wheel cover portions when engaged with the protective protrusion extending from the first of the at least two wheel cover portions retains the at least one opposed side bearing race in said at least one opposed bearing race groove.

6. The aircraft wheel hub cover of claim 1, wherein the protective protrusion extending from the first and second of the at least two wheel cover portions form and are releasably coupled by at least one of an at least one paired thread/thread receiving portion, a set of pressure release components, and a slip fit coupling with a push-press release component, thereby affixing the aircraft wheel hub cover to the aircraft wheel.

7. The aircraft wheel hub cover of claim 1, wherein the protective protrusion extending from the first of the at least two wheel cover portions has a threaded portion thereon.

8. The aircraft wheel hub cover portion of claim 7, wherein the protective protrusion extending from the second of the at least two wheel cover portions has a thread receiving portion thereon and wherein said protective portions are screwed together by engaging the respective threaded and thread receiving portions to removable affix the wheel hub cover portion.

9. The aircraft wheel hub cover portion of claim 1, wherein the protective protrusion extending from the first of the at least two wheel cover portions has a thread portion thereon and said protrusion from said first of the at least two cover portions extends fully through the axle void to mate with the second of the at least two cover portions which has a threaded receiving portion as the second protective protrusion within the second of the at least two cover portions, wherein said protective portions are screwed together by engaging the respective threaded and thread receiving portions to removably affix the wheel hub cover to the aircraft wheel.

10. An aircraft wheel hub cover configured to be removably affixed on an aircraft wheel having a rim and a hub with a support portion of the hub that extends radially inward from the rim in the radially middle portion of the rim with an at least one bearing race groove thereon, an at least one bearing race located in an at least one bearing race groove, and an axle void passing through the hub on the rim, comprising:
at least two wheel hub cover portions;
a first wheel hub cover portion of the at least two wheel hub cover portions on a first side of said wheel;
a second wheel hub cover portion of the at least two wheel hub cover portions on an opposed side of the wheel relative to the first;
an at least one integral protection protrusion portion extending from said first wheel hub cover portion of the at least two wheel hub cover portions, with the at least one integral protection protrusion engaging said support portion of the hub with said at least one bearing race groove thereon on at least one side of said wheel and penetrating and extending into the axle void from the first side to the second side of said wheel, wherein the at least one integral protection protrusion extending from the first of the least two wheel hub cover portions retains said at least one bearing race in the at least one bearing race groove and engages the second cover portion of the at least two cover portions such that the at least one integral protection protrusion releasably couples the first wheel hub cover portion to the opposed second wheel hub cover portion and thereby releasably affixes the wheel cover to the aircraft wheel.

11. The aircraft wheel hub cover of claim 10, further comprising an opposed side support portion of the hub that extends radially inward from the opposed side of the rim on the opposed side of the wheel in the radially middle portion of the opposed side of the rim with an at least one opposed side bearing race groove thereon and wherein the at least one protective protrusion further comprises a second protective protrusion of the at least one protrusion extending from the second of the at least two wheel cover portions and engaging said opposed support portion of the hub.

12. The aircraft wheel hub cover of claim 11, further comprising an at least one opposed side bearing race seated in an at least one opposed bearing race groove in the opposed support portion.

13. The aircraft wheel hub cover of claim 12, wherein the protective protrusion extending from the first of the at least two wheel cover portions has a threaded portion thereon.

14. The aircraft wheel hub cover portion of claim 13, wherein the protective protrusion extending from the second of the at least two wheel cover portions has a thread receiving portion thereon and wherein said protective portions are screwed together by engaging the respective threaded and thread receiving portions to removable affix the wheel hub cover portion.

15. The aircraft wheel hub cover of claim 14, wherein the second protective protrusion of the at least one protective protrusion is engaged with the first protective protrusion of the at least two protective protrusions such that the threaded portion and the thread receiving portions are turned to engage one another and the at least two wheel cover portions retains the at least one opposed side bearing race in said at least one opposed bearing race groove.

16. The aircraft wheel hub cover of claim 10, wherein the at least one protective protrusion extending from the first of the at least two wheel cover portions is releasably coupled by at least one of an at least threaded portion, a set of pressure release components, a slip fit coupling with a push-press release component, thereby releasably affixing the aircraft wheel hub cover to the aircraft wheel.

17. The aircraft wheel hub cover portion of claim 10, wherein the at least one protective protrusion extending from the first of the at least two wheel cover portions has a thread portion thereon and extends fully through the axle void to mate with an at least one thread receiving portion within the second of the at least two cover portions, wherein said protective portions are screwed together by engaging the respective threaded and thread receiving portions to removably affix the wheel hub cover to the aircraft wheel.

18. A method of using an aircraft wheel cover such that an at least one protective protrusion is engaged and retains an at least one bearing race in a support portion of the wheel on an aircraft wheel, comprising:
aligning a first of an at least two wheel cover portions, the first wheel cover portion having an at least one protrusion thereon, the at least one protrusion being aligned with an axle void;
passing the at least one protective protrusion into the axle void in the aircraft wheel, the aircraft wheel having aircraft wheel having a rim and a hub with the support portion of the hub that extends radially inward from the rim in the radially middle portion of the rim with an at least one bearing race groove thereon, the at least one protrusion thereon being thereby engaged with the aircraft wheel such that the protrusion extends to and engages a second wheel cover portion of the at least two cover portions through the axle void in the hub;
engaging an at least one coupling portion of the at least one protrusion to releasably affix the first cover portion of the at least two cover portions to the second cover portion of the at least two cover portions; and
securing and retaining the at least one bearing race in the support portion of the wheel while the aircraft wheel cover is releasably affixed.
